(19) United States
(12) Patent Application Publication
(10) Pub. No.: US 2007/0203802 A1
(43) Pub. Date: Aug. 30, 2007

(54) METHOD FOR COLLECTING, TESTING AND DISTRIBUTING MILK

(75) Inventors: Elena Maria Medo, Murrieta, CA (US); Martin L. Lee, Studio City, CA (US); David Rechtman, Hermosa Beach, CA (US)

Correspondence Address: BUCHANAN, INGERSOLL & ROONEY LLP, P.O. BOX 1404, ALEXANDRIA, VA, 22313-1404, US

(73) Assignee: PROLACTA BIOSCIENCE, INC., Monrovia, CA (US)

(21) Appl. No.: 11/679,546

(22) Filed: Feb. 27, 2007

Related U.S. Application Data
(63) Continuation-in-part of application No. 11/526,127, filed on Sep. 22, 2006.
(60) Provisional application No. 60/720,192, filed on Sep. 23, 2005.

(51) Int. Cl. G06Q 30/00

(52) U.S. Cl. 705/26

(57) ABSTRACT

The disclosure is related generally to a method for facilitating the collection and distribution of milk over a computer network among a milk provider, a milk company and a milk distribution center.

CROSS REFERENCE TO RELATED APPLICATIONS

This application is a continuation-in-part application of U.S. patent application Ser. No. 11/526,127, filed Sep. 22, 2006, which claims priority to provisional application 60/720,192, filed Sep. 23, 2005, the disclosure of which is incorporated herein by reference.

### FIELD OF THE INVENTION

The invention is related generally to a method for monitoring, collection and distributing human milk.

### BACKGROUND

Unlike blood providers who give their donation under the direct supervision of the blood bank personnel, human breast milk providers tend to pump their milk at home or other locations convenient to them and then store the breast milk in their freezers until they have accumulated enough to bring to the milk collection center.

Generally, the milk providers need to be physically close to a hospital or other recognized milk collection/distribution center. This physical proximity of the providers to the collection center allows the collection center to screen the providers. It also provides a location where the providers can drop off the expressed milk in a timely manner.

Generally, the collection center also provides the milk to infants who require the milk. Thus the quantity of milk available to the infants is dependent on the number of providers located in the immediate vicinity of the collection center.

It would be advantageous if there was a method for collecting milk from providers physically located away from collection centers/hospitals as this would increase the population of providers. It would be advantageous if there was a central repository for the testing and distribution of the milk. This would allow the quality of the milk to be monitored and it would allow centers which require the milk to obtain the milk from a wider geographic region.

Thus, a method and system for efficient collection, demand, supply, delivery and payment for milk is needed to more evenly distribute the benefits and burdens of the industry.

### SUMMARY

This invention is directed to a method for facilitating the collection, delivery and supply for milk (e.g., human milk).

In one embodiment, the invention is directed to a method for facilitating the collection and distribution of human milk over a computer network among a milk provider, a milk company, and a milk distribution center comprising the steps of: qualifying, by said milk company, at least one provider to participate; providing a provider account code wherein said provider code corresponds to the qualification information for that provider, receiving filled first milk containers bearing the provider code from the provider; establishing a database for facilitating on-line display of a plurality of descriptive line items corresponding to, respectively, at least one of the filled milk containers, wherein each of said descriptive line items comprises an identification of the milk, including the quantity, quality and provider code; processing said human milk and filling second milk containers for shipment; and effecting the shipment of second filled milk containers to a distribution center.

It is contemplated that the method may further comprise the step of providing empty first milk containers to the provider.

It is contemplated that the method may further comprise establishing a relationship with a milk collection center. It is contemplated that the milk collection center may qualify the provider of the milk. It is further contemplated that the milk collection center may provide the qualification data directly to the milk company or to the database.

It is contemplated that the provider may ship the filled milk containers directly to the milk company. Alternatively, the provider may deliver or ship the filled milk containers to the milk collection center and the milk collection center will in turn ship the filled milk containers to the milk company. In one embodiment the unique code is a bar code. In another aspect, the milk is tested for viral and bacterial contaminants.

These and other aspects of the invention will become more evident upon reference to the following detailed description and attached drawings. It is to be understood however that various changes, alterations and substitutions may be made to the specific embodiments disclosed herein without departing from their essential spirit and scope. In addition, it is further understood that the drawings are intended to be illustrative and symbolic representations of an exemplary embodiment of the invention and that other non-illustrated embodiments are within the scope of the invention.

### BRIEF DESCRIPTION OF THE DRAWINGS

The subject of the invention will hereinafter be described in the context of the appended drawing figures wherein the numerals denote like elements or steps.

FIG. 1 illustrates the key to the symbols in the other figures in accordance with an exemplary embodiment of the invention.

FIG. 2 illustrates the system for initial interview screening of the female provider in accordance with an exemplary embodiment of the invention.

FIG. 3 illustrates the system for completed screening of female provider, provision of collection bottles and collection of expressed human breast milk in accordance with an exemplary embodiment of the invention.

FIG. 4 illustrates the system for transfer of milk to the company and review of the milk in accordance with an exemplary embodiment of the invention.

FIG. 5 illustrates the system for quality testing of the expressed breast milk, assignment of lot number and distribution to milk distribution center in accordance with an exemplary embodiment of the invention.

FIG. 6 illustrates the system for re-qualification of the human provider in accordance with an exemplary embodiment of the invention.

### DETAILED DESCRIPTION

Unless defined otherwise, technical and scientific terms used herein have the same meaning as commonly understood by one of skill in the art to which this invention belongs. All references cited herein are incorporated by reference in their entirety.

The “milk collection center” is a location where the milk providers or mothers can deliver the milk. The milk collection center is also the location where the providers or mothers can be initially screened for qualifications for providing the milk. The milk collection center may be a hospital, or a local health clinic or other health facility. It is contemplated that the milk collection center may be one center for the initial screening and a different center for the delivery of the milk. It is not required that the milk collection center remain the same location or physical or company entity throughout the process.

The “mother” or “provider” is the lactating mother who has offered to provide her expressed milk for this purpose. It is contemplated that the milk will be donated, but the milk may be purchased. The “mother” becomes “qualified” to provide the milk following biological testing and identifying characteristics of the donor during the process of this invention.

A “milk company” is the company or hospital that coordinates the process of the invention. The milk company maintains the database or has the database maintained. The milk company may receive and ship the milk. It is contemplated that the milk company may arrange for the milk to be provided, collected and shipped or monitored by the methods of this invention.

A “reference laboratory” is a laboratory for conducting testing of biological samples and/or milk samples. The reference laboratory for conducting tests on the biological samples may differ from the laboratory used to conduct tests of the milk samples. Furthermore the “reference laboratory” may be the milk company or hospital.

A “milk distributor” is a location which will accept the provided milk and distribute it to persons requiring the milk. Exemplary embodiments of a milk distributor are a hospital or milk bank or health clinic or other recognized distributor of human milk.

One skilled in the art will recognize many methods and materials similar or equivalent to those described herein, which could be used in the practice of this invention. Indeed the invention is in no way limited to the methods and materials described herein.

In general the invention includes a unique method for screening milk providers, collecting milk (e.g., expressed human breast milk), testing the milk and distributing the milk to distribution centers. The system communicates with and takes advantage of existing collection, transportation, tracking, distribution and banking systems to increase the collection, testing and distribution of the human breast milk. The interactive database includes real-time information in connection with a transaction.

The invention enhances extranet functionality by substantially reducing the providers, collection agencies and distributors actions in the milk process by providing an integration of systems to maximize convenience and efficiency. In general, the invention performs various functions for the providers, collection centers and distribution centers thereby allowing real-time transactions. For example, the invention pre-qualifies providers, provides databases and financial relationships to assist in the collection of milk.

In another aspect, the invention provides data regarding a mother's milk composition including, but not limited to, fat content, protein content and the like. For example, in a hospital setting a mother may wish to use her own milk to feed a newborn in the hospital. In such instances, the milk can be expressed by the mother, collected, tracked, analyzed and modified to adjust the caloric, protein, or other content of the milk and then distributed to the mother's own child.

The system provides connections to transportation systems to enhance scheduling and tracking of products. In an exemplary embodiment the present system communicates with a shipper's (e.g., Federal Express and/or United Parcel Service) system or courier service and database to share its credit information, shipping information, tracking information and the like thereby enhancing the functionality of the system. The system provides a database for tracking the qualifications of a subject provider (e.g., a human provider) and the quality of the milk.

In one embodiment, the invention pertains to a system of milk collection and distribution running over the a network of computers (e.g., the Internet). It will be appreciated however, that many applications of the invention could be formulated. One skilled in the art will appreciate that the network may include any system for exchanging data or transacting business, such as the Internet, an intranet, an extranet, WAN, LAN, satellite communications, and/or the like. The users may interact with the system via any input device such as a keyboard, mouse, kiosk, personal digital assistant, handheld computer (e.g., Palm Pilot®), cellular phone and/or the like. Similarly, the invention could be used in conjunction with any type of personal computer, network computer, workstation, minicomputer, mainframe, or the like running any operating system such as any version of Windows, Windows NT, Windows XP, Windows 2000, Windows 98, Windows 95, MacOS, OS/2, BeOS, Linux, UNIX, or the like. Moreover, it will be readily understood that the invention could be implemented using TCP/IP communications protocols, IPX, Appletalk, IP-6, NetBIOS, OSI or any number of existing or future protocols.

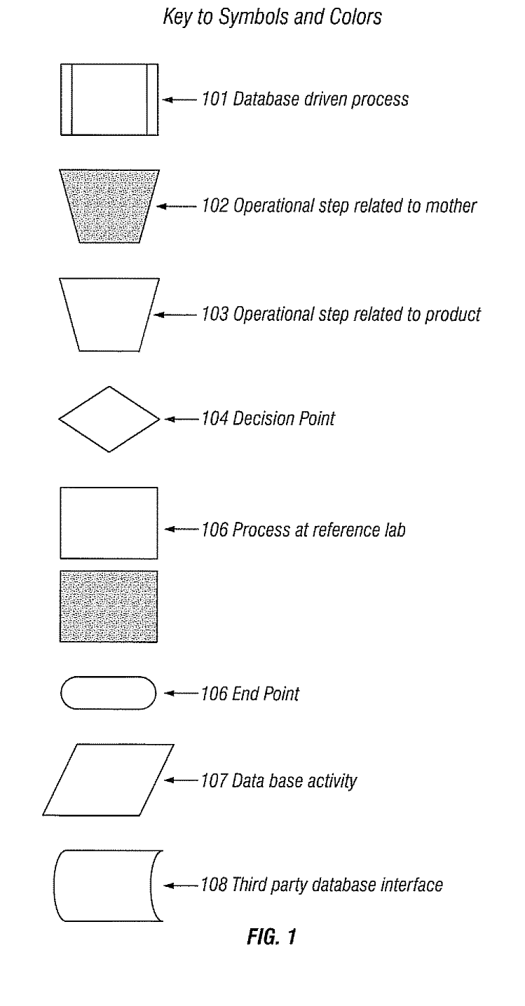

More particularly, with respect to FIG. 1, various types of operations are shown. The various operations include 101 database driven process; 102 operations related to the mother or provider; 103 operations related to the donated milk product; 104 decision point; 105 process step at the reference laboratory; 106 end point; 107 database activity; and 108 third party database interface. The third party could be any party given access to the database. Such access may be by way of the internet or other means known in the art. Such access may be limited to entry of data into the database or access to limited information from the database. Possible third parties include the milk company, the milk collection center, the milk distribution center, the reference laboratory, and the milk provider. For example, the milk collection center may be able to enter the information regarding the provider and the number of milk containers provided to the mother and collected from the mother and the quality of the milk. The reference laboratory may be able to enter the results from the biological tests conducted.

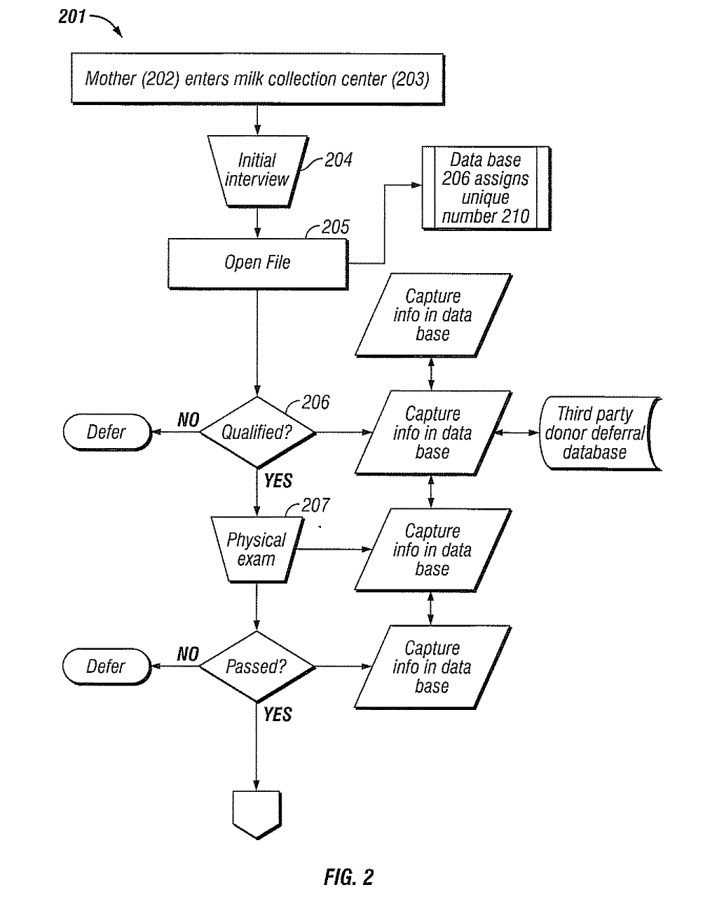

Referring now to FIG. 2, a system 201 for initial interview screening of a female provider is provided in accordance with an exemplary embodiment of the invention. System 201 includes a mother or milk provider 202 and a milk collection center 203. Interactive database 206 provides an on-line database for the various parties to access to assist in carrying out a transaction.

For example, interactive database 206 may be stored on a server such that each party may access interactive database 206 via a web site for on-line interactive communication. of course, interactive database 206 may be implemented in any number of communication systems, including wireless communication, packet switched networks (e.g. via an Internet service Provider (ISP)), wired communication, intranet, extranet, and the like. To further illustrate the variety of communication media that interactive database 206 may be implemented in laptops, cellular phones, personal digital assistant (PDA) technology, modems, and the like may be used.

To understand an exemplary method of conducting business using system 201, Fig, 2 also illustrates the various steps in a transaction. The putative provider 202, contacts the milk collection center 203. The milk collection center 203 interviews and/or test the potential milk provider 202 to determine whether the provider 202 would be suitable as a milk provider (204). The milk collection center 203 opens a file (205) for the milk provider 202 and the database 206 assigns a unique provider code 210 to the milk provider 202. In some aspect, the same unique provider code will be assigned to a child of the donor to facilitate matching the donated mother's milk to the child. If the milk provider 202 passes the initial qualification screening (204) this result is captured into the database 206 under the unique provider code 210.

Technicians of the milk collection center 203 or doctors conduct a physical examination (207) of the milk provider 202. This physical examination may be conducted at this time or may have been conducted at an earlier date and the health of the provider certified by a physician. If the milk provider 202 passes the physical examination, this result is captured into the database 206 under the unique provider code. If the milk provider 202 does not pass either the initial interview or the physical examination, the provider is rejected.

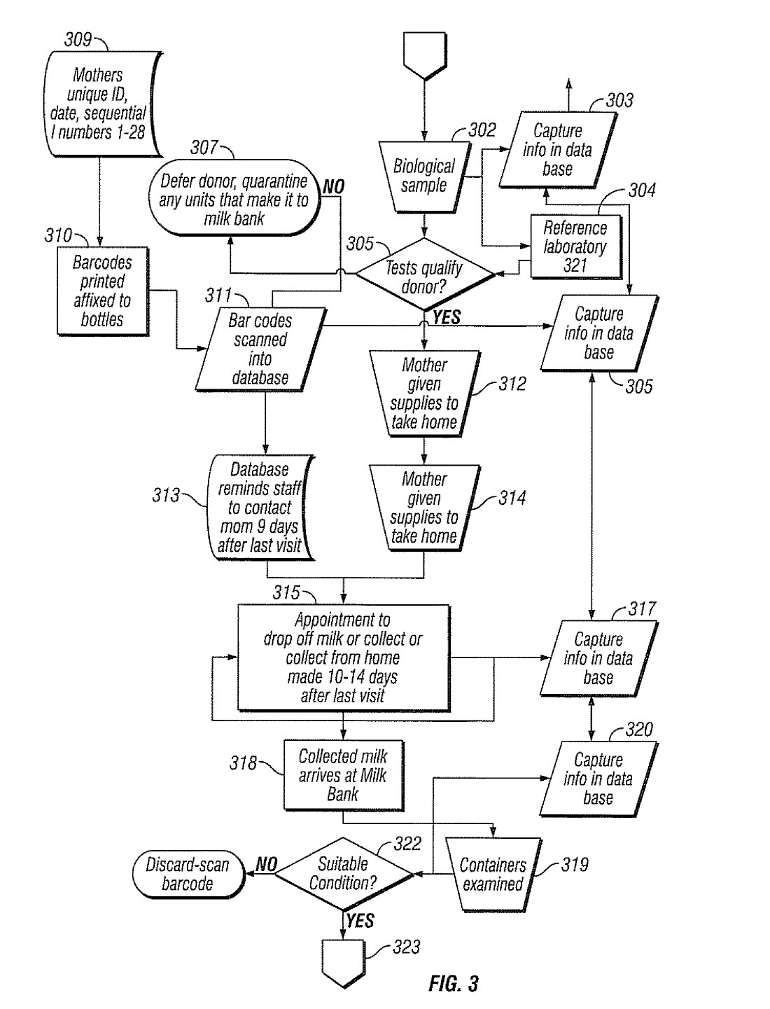

Turning now to FIG. 3, if the milk provider 202 passes both the initial interview and the physical examination, biological samples are taken from the provider 202 (302). An indication that biological samples were drawn is entered into the database (303). The biological samples are sent to a reference laboratory 321 for analysis (304). The laboratory 321 analyzes the biological samples and the results are entered into the database 206 under the provider's unique code 210 (305). The reference laboratory 321 may have direct access to the database 206 for entering the information or they may report the information to the milk company for entry into the database. Such reporting may be in paper or electronic form. In one aspect, the biological sample is the expressed milk.

The biological tests which are conducted may include viral and biological analysis known in the art. Such tests may include testing for human viruses such as HIV1/2, HTLVI/II, HBV, HCV, and the like. Such tests may include testing for bacterial diseases such as syphilis and tuberculosis. In addition, the expressed milk can be tested for caloric content, protein content, IgG content, and may include a panel of test for drugs and pathogens.

Such testing may also include identification of unique identity markers to identify the provider, such testing may include nucleic acid testing or peptide or antibody testing. The disclosure of U.S. Ser. Nos. 60/719,317, filed Sep. 20, 2005, and 60/731,428, filed Oct. 28, 2005, and International Application PCT/US2006/036827, entitled “Method of Testing Milk,” filed Sep. 20, 2006 are incorporated herein by reference.

If the biological tests disqualify the milk provider 202 as a provider, all milk provided by that mother is quarantined and destroyed (307). If the biological tests qualify the milk provider 202 as a provider, labels 309 are printed with the provider's unique code and affixed to the milk containers (310). The unique codes on the containers are entered into the database (311). In one aspect, the donated milk is analyzed for caloric content or protein content. Where the milk does not meet an optimal range of caloric content or protein content, the milk may be concentrated or modified by addition of a human milk fortifier to provide a target of about 3-10 kcal/oz (e.g., about 4, 6, 8, or 10 kcal/oz) and about 1-6 grams of protein/100 ml (e.g., about 2.1, 2.5, 2.9 or 3.4 grams/100 ml). The expressed or modified milk product will then be returned to the mother or distributed to a neonatal unit for administration to the mother's infant. The correct infant is matched with the milk using a code on the bottle and a code associated with the infant or mother.

The milk containers may be bottles or bags. The bottles may be glass or plastic. The provider 202 takes the labeled bottles home (312). On an as needed basis, the provider (202) expresses her milk into the milk containers and freezes the containers containing the milk (314). It is contemplated that step 314 could occur a number of times in a day and/or on a daily basis.

The database 206 sends a timed reminder to the milk company to contact the provider 202 at an appropriate interval after the last visit to the collection center 203 to schedule pick-up or delivery of the filled milk containers (313). This interval can be at least 5 days, at least 7 days, at least 9 days, at least 11 days, and/or at least 14 days. The days may be calendar days or business days after the provider's 202 last visit. It is contemplated that the milk will be collected in sufficient time to maintain the quality of the milk.

The milk company or hospital contacts the provider and arranges an appointment to collect milk (e.g., previously expressed and frozen stored milk containers) (315). The filled milk containers may be delivered by the provider 202 to the milk collection center or hospital 203, or the milk may be collected using a freight service (318). The number of containers of milk delivered to the milk collection center 203 is recorded in the database 206 (317). The filled milk containers are examined (319)and the condition of the containers recorded in the database 206 (320). If in suitable condition the milk containers are shipped to the milk company (323). If the containers are not in suitable condition the containers and milk are discarded (322).

It is contemplated that the milk containers may be directly shipped to the milk company rather than to the milk collection center 203 by the freight company.

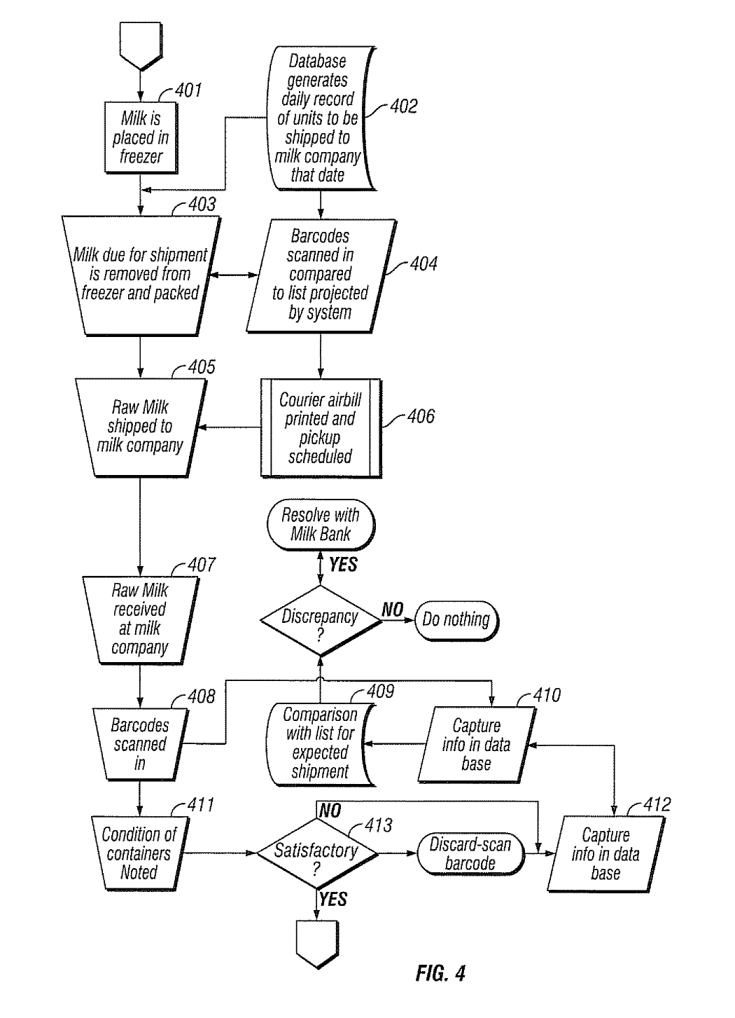

Turning now to FIG. 4, the milk can be placed in the freezer at the milk collection center (401). The database 206 generates a record of the units to be shipped to the milk company each day (402). The milk due for shipment is removed from storage (e.g., from a freezer) and the unique provider codes entered into the database (404). The milk containers to be shipped are packed for transport internally or externally (403). A courier airbill or bill of lading or transport notice is printed and shipment by a freight courier or other method is scheduled (406). The milk containers are shipped to the milk company by a courier (405).

The milk containers are received at the milk company (407). The unique provider codes are scanned into the database 206 (408) and compared to the list for shipment. (409 and 410) The condition of the milk containers is noted (411). If the condition of the milk container is not acceptable, the label 309 is removed, the condition is entered into the database and the milk discarded (413).

If the condition of the milk container is acceptable, a sample of the milk is obtained from each container (501). It also is contemplated that not every milk container from each provider will be sampled, rather it is contemplated that a representative number of milk containers may be sampled and tested. It is also contemplated more than one sample could be taken. The taking of the sample is recorded in the database 206 (502). Methods of obtaining a sample of the expressed milk include a stainless steel boring tool used to drill a core the entire length of the container Alternatively, a sample may be scraped from the surface of the frozen milk or pipetted by sterile pipette. The container may contain a separate portion which collects a sample of the expressed milk and this may be removed as the sample. The milk may be thawed and a sample isolated by pipette or other means.

It is contemplated that some samples may be pooled for the testing step. It is contemplated that pooled samples may be tested for presence of drugs or the presence of bacterial or viral contamination or caloric/protein content.

The milk sample is sent to the reference laboratory 321 for testing. This is recorded in the database 206 (502). The sample is tested at the reference laboratory for donor identity (505). It is contemplated that other testing for bacterial or viral infection and or presence of drags may also occur. In some aspect, the milk composition including, but not limited to, fat content, caloric content, protein content and like nutritional information may be analyzed.

The milk container is placed into quarantine pending the lab test results from the reference laboratory (504). If the milk sample is confirmed to originate from the provider 202 and there are no contaminants, the containers corresponding to the accepted sample are removed from the freezer for further processing (509 and 510). This information is stored in the database 206 and the provider 202 remains qualified (512).

If the milk sample does not pass the tests, the milk containers are discarded and the provider milk provider 202 indicated as disqualified (506). This information is captured in the database 206 (507).

The acceptable milk containers are sent for manufacturing and processing (511 and 513). It is contemplated that the milk after manufacturing and processing may be further tested for the presence of bacterial or viral contamination.

A lot number is assigned to the processed milk and attached to the final or second milk containers (514 and 515). The finished product (second filled milk containers) is placed in the freezer (516). The distribution center's (518) shipping data is printed on a label and affixed to the milk product (519). The information is entered into the database 206. (517) The product is shipped to the distribution center 518 by freight carrier (520).

In some aspect, where the nutritional content of the milk is tested, the nutritional content is entered in to the database and may be printed and associated with the collected bottles or lots. In some aspects, the nutritional content is modified and the modifications noted in the database and on the bottle or lot.

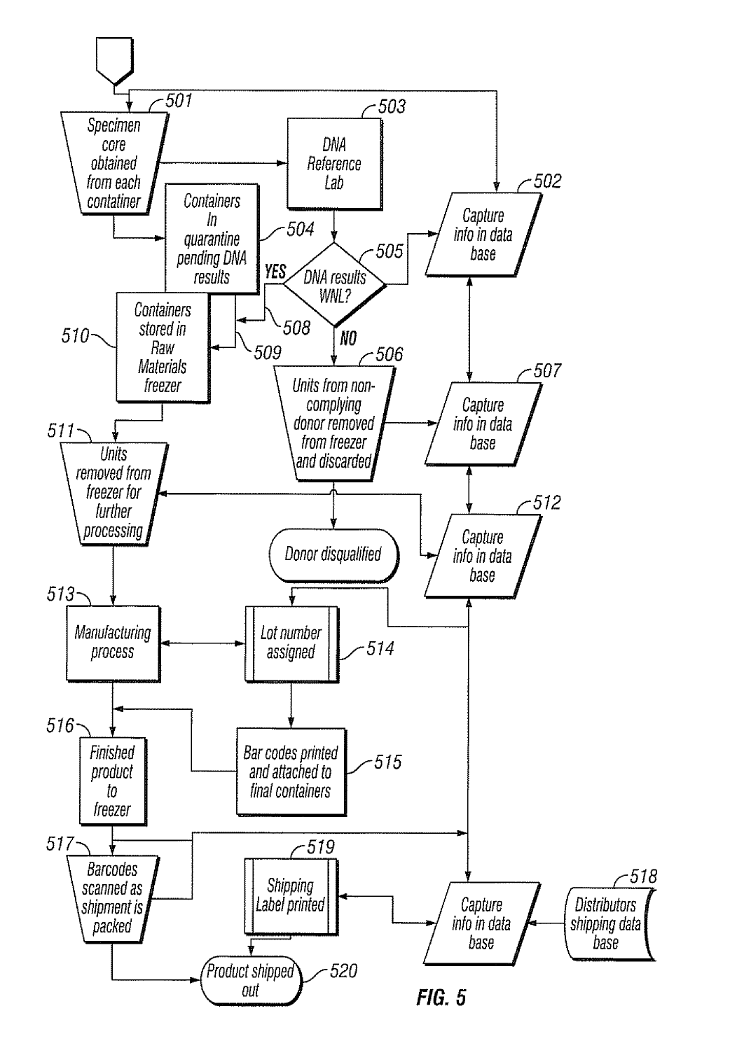

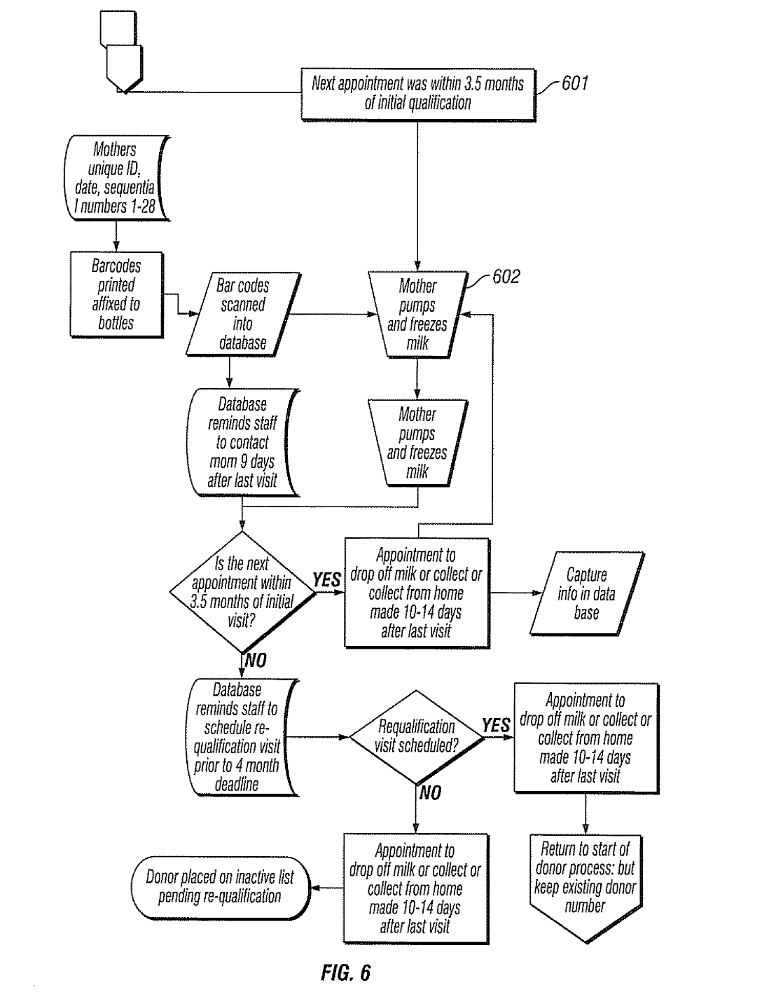

Turning now to FIG. 6, If the provider 202 passes the initial qualification, the database schedules another qualification appointment. This subsequent qualification appointment is scheduled for at least 1 month from the initial appointment, or at least 2 months from the appointment or at least 3 months from the appointment or at least 4 months from the appointment (601). The Provider 202 repeats all of the steps in FIGS. 2 and 3 up to 308. The provider 202 is given empty milk containers having the providers unique identity code (602) and the process set forth in FIGS. 3-5 is repeated until the provider fails qualification or decides to leave the program.

The various techniques, methods, and aspects of the invention described herein can be implemented in part or in whole using computer-based systems and methods. Additionally, computer-based systems and methods can be used to augment or enhance the functionality described herein, increase the speed at which the methods can be performed, and provide additional features and aspects as a part of or in addition to those of the invention described elsewhere in this document. Various computer-based systems, methods and implementations in accordance with the above-described technology are presented below.

A processor-based system can include a main memory, such as random access memory (RAM), and can also include a secondary memory. The secondary memory can include, for example, a hard disk drive and/or a removable storage drive, representing a floppy disk drive, a magnetic tape drive, an optical disk drive, flash drive, and the like. The removable storage drive reads from and/or writes to a removable storage medium. Removable storage medium refers to a floppy disk, magnetic tape, optical disk, and the like, which is read by and written to by a removable storage drive. As will be appreciated, the removable storage medium can comprise computer software and/or data.

In alternative embodiments, a secondary memory may include other similar means for allowing computer programs or other instructions to be loaded into a computer system. Such means can include, for example, a removable storage unit and an interface. Examples of such can include a program cartridge and cartridge interface (such as the found in video game devices), a movable memory chip (such as an EPROM or PROM) and associated socket, and other removable storage units and interfaces, which allow software and data to be transferred from the removable storage unit to the computer system.

The computer system can also include a communications interface. Communications interfaces allow software and data to be transferred between computer system and external devices. Examples of communications interfaces can include a modem, a network interface (such as, for example, an Ethernet card), a communications port, a PCMCIA slot and card, and the like. Software and data transferred via a communications interface are in the form of signals, which can be electronic, electromagnetic, optical or other signals capable of being received by a communications interface. These signals are provided to communications interface via a channel capable of carrying signals and can be implemented using a wireless medium, wire or cable, fiber optics or other communications medium. Some examples of a channel can include a phone line, a cellular phone link, an RF link, a network interface, and other communications channels.

In this document, the terms “computer program medium” and “computer usable medium” and “computer readable medium” are used to refer generally to media such as a removable storage device, a disk capable of installation in a disk drive, and signals on a channel. These computer program products are means for providing software or program instructions to a computer system.

Computer programs (also called computer control logic) are stored in main memory and/or secondary memory. Computer programs can also be received via a communications interface. Such computer programs, when executed, enable the computer system to perform the features of the invention as discussed herein. In particular, the computer programs, when executed, enable the processor to perform the features of the invention. Accordingly, such computer programs represent controllers of the computer system.

In an embodiment where the elements are implemented using software, the software may be stored in, or transmitted via, a computer program product and loaded into a computer system using a removable storage drive, hard drive or communications interface. The control logic (software), when executed by the processor, causes the processor to perform the functions of the invention as described herein.

In another embodiment, the elements are implemented primarily in hardware using, for example, hardware components such as PALs, application specific integrated circuits (ASICs) or other hardware components. Implementation of a hardware state machine so as to perform the functions described herein will be apparent to person skilled in the relevant art(s). In yet another embodiment, elements are implanted using a combination of both hardware and software.

In another embodiment, the computer-based methods can be accessed or implemented over the World Wide Web by providing access via a Web Page to the methods of the invention. Accordingly, the Web Page is identified by a Universal Resource Locator (URL). The URL denotes both the server machine and the particular file or page on that machine. In this embodiment, it is envisioned that a consumer or client computer system interacts with a browser to select a particular URL, which in turn causes the browser to send a request for that URL or page to the server identified in the URL. Typically the server responds to the request by retrieving the requested page and transmitting the data for that page back to the requesting client computer system (the client/server interaction is typically performed in accordance with the hypertext transport protocol (“HTTP”)). The selected page is then displayed to the user on the client's display screen. The client may then cause the server containing a computer program of the invention to launch an application to, for example, perform an analysis according to the invention.

A number of embodiments have been described. Nevertheless, it will be understood that various modifications may be made without departing from the spirit and scope of the description. Accordingly, other embodiments are within the scope of the following claims.

What is claimed is:

1. A method for facilitating the collection and distribution of a mother's milk over a computer network comprising:
qualifying a mother;
providing a provider account code wherein said provider code corresponds to the qualification information for the mother;
receiving a filled first milk containers bearing the provider code from the mother;
establishing a database for facilitating display of a plurality of descriptive line items of the filled milk containers, wherein each of said descriptive line items comprises an identification of the milk, comprising the quantity, quality and/or provider code;
processing the mother's milk; and
effecting the shipment of the processed mother's milk to the mother or an infant.

2. The method of claim 1, further comprising the step of providing empty first milk containers to the mother.

3. The method of claim 1, wherein the infant is the mother's own infant.

4. The method of claim 1, wherein the processing comprises analyzing the mother's milk to determine the nutritional value.

5. The method of claim 1, wherein the processing comprises analyzing the mother's milk to determine the nutritional value of the milk and change a nutritional value of the mother's milk.

6. The method of claim 1, wherein the provider account code is a bar code.

7. The method of claim 1, wherein the mother's milk is processed to test for viral and bacterial contaminants.

8. The method of claim 1, wherein the provider code is associated with the infant.

9. The method of claim 1, implemented by a computer.

10. A computer program on computer readable medium, comprising instructions to cause a computer to:
provide a provider account code to a mother wherein the provider account code corresponds to the qualification information for the qualified mother;
process a filled first milk container bearing the provider account code from the qualified mother comprising associating a plurality of descriptive line items of the filled milk container comprising an identification of the milk, comprising the quantity, quality and/or provider account code;
process the filled first milk container; and
effect the shipment of the filled milk containers to a distribution center, the mother or an infant.

11. The computer program of claim 10, further comprising causing the identification of a relationship with a mother and an infant.

12. The computer program of claim 10, wherein the provider account code is a bar code.

15. The computer program of claim 10, wherein the processing of the milk comprises testing the milk for nutritional value, viral and/or bacterial contaminants.
